(19) United States
(12) Patent Application Publication
(10) Pub. No.: US 2019/0155306 A1
(43) Pub. Date: May 23, 2019

(54) Hybrid Maps - Boundary Transition

(71) Applicant: Uber Technologies, Inc., San Francisco, CA (US)

(72) Inventors: Gordon Peter Bailey, Pittsburgh, PA (US); Bryan John Nagy, Allison Park, PA (US); Adam Henry Polk Milstein, Pittsburgh, PA (US); Robert Michael Zlot, Pittsburgh, PA (US); Adam Cole Panzica, Pittsburgh, PA (US); Brett Bavar, Glenshaw, PA (US); David Peter Prasser, Pittsburgh, PA (US); Peter Ian Hansen, Pittsburgh, PA (US); Ethan Duff Eade, Pittsburgh, PA (US); Xxx Xinjilefu, Pittsburgh, PA (US); Brett Browning, Pittsburgh, PA (US)

(21) Appl. No.: 15/903,435

(22) Filed: Feb. 23, 2018

Related U.S. Application Data
(60) Provisional application No. 62/590,074, filed on Nov. 22, 2017.

(51) Int. Cl. G05D 1/02

(52) U.S. Cl. CPC G05D 1/0274; G05D 2201/0213; G05D 1/024

(57) ABSTRACT

An autonomous vehicle (AV) includes a vehicle computing system including one or more processors configured to receive map data associated with a map of a geographic location, determine, based on the map data, that the AV is on a coverage lane, and, in response to determining that the AV is on the coverage lane, control the AV to maintain at least one functionality associated with a fully-autonomous mode. The map includes (i) a coverage lane where the AV can operate and/or travel under a partially-autonomous mode or a manual mode, and (ii) an AV lane where the AV can operate and/or travel under the fully-autonomous mode. The coverage lane is linked to the AV lane.

### CROSS REFERENCE TO RELATED APPLICATION

This application claims the benefit of U.S. Provisional Application No. 62/590,074, filed Nov. 22, 2017, the entire disclosure of which is hereby incorporated by reference in its entirety.

### BACKGROUND

An autonomous vehicle (AV) (e.g., a driverless car, a driverless auto, a self-driving car, a robotic car, etc.) is a vehicle that is capable of sensing an environment of the vehicle and traveling (e.g., navigating, moving, etc.) in the environment without human input. An AV uses a variety of techniques to detect the environment of the AV, such as radar, laser light, Global Positioning System (GPS), odometry, and/or computer vision. In some instances, an AV uses a control system to interpret information received from one or more sensors, to identify a route for traveling, to identify an obstacle in a route, and to identify relevant traffic signs associated with a route.

### SUMMARY

According to some non-limiting embodiments or aspects, provided is an autonomous vehicle (AV) including a vehicle computing system including one or more processors, wherein the vehicle computing system is configured to: receive map data associated with a map of a geographic location, the map including (i) a coverage lane where the AV can operate and/or travel under a partially-autonomous mode or a manual mode, and (ii) an AV lane where the AV can operate and/or travel under a fully-autonomous mode, wherein the coverage lane is linked to the AV lane; determine, based on the map data, that the AV is on the coverage lane; and in response to determining that the AV is on the coverage lane, control the AV to maintain at least one functionality associated with the fully-autonomous mode.

In some non-limiting embodiments or aspects, the vehicle computing system is further configured to: determine, based on the map data, that the AV has transitioned from the coverage lane to the AV lane; and in response to determining that that the AV has transitioned from the coverage lane to the AV lane, control the AV to enter the fully-autonomous mode.

In some non-limiting embodiments or aspects, the AV further includes one or more sensors configured to detect an object in an environment surrounding the AV, and the vehicle computing system is further configured to: control the AV to maintain the at least one functionality associated with the fully-autonomous mode in the coverage lane based on sensor data from the one or more sensors and the map data.

In some non-limiting embodiments or aspects, the one or more sensors include a light detection and ranging (LIDAR) system, the LIDAR system is or configured to determine sensor point data associated with a location of a number of points that correspond to objects within the environment of the AV, the map data includes map point data associated with a location of a number of points that correspond to objects that have reflected a ranging laser during one or more traversals of the coverage lane location by one or more mapping AVs, and the vehicle computing system is further configured to: control the AV to maintain the at least one functionality associated with the fully-autonomous mode to determine a position of the AV in the coverage lane based on the sensor point data and the map point data.

In some non-limiting embodiments or aspects, the map data is associated with a location of a number of points that correspond to objects that have reflected a ranging laser during one or more traversals of the coverage lane by one or more mapping AVs.

In some non-limiting embodiments or aspects, the at least one functionality associated with the fully-autonomous mode determines operation data in the coverage lane, and the vehicle computing system is further configured to: control the AV to perform the at least one functionality in the AV lane in the fully-autonomous mode based on the operation data determined in the coverage lane.

In some non-limiting embodiments or aspects, the map data is associated with a link between the AV lane and the coverage lane, the AV further includes a positioning system configured to determine a position of the AV, and the vehicle computing system is further configured to: determine the position of the AV with respect to the link between the AV lane and the coverage lane based on positioning data from the positioning system and the map data; and control the AV to maintain the at least one functionality associated with the fully-autonomous mode in the coverage lane based on the position of the AV with respect to the link between the AV lane and the coverage lane.

According to some non-limiting embodiments or aspects, a method includes receiving, with a computer system including one or more processors, map data associated with a map of a geographic location, the map including (i) a coverage lane where an autonomous vehicle (AV) can operate and/or travel under a partially-autonomous mode or a manual mode, and (ii) an AV lane where the AV can operate and/or travel under a fully-autonomous mode, wherein the coverage lane is linked to the AV lane; determining, based on the map data with the computer system, that the AV is on the coverage lane; and in response to determining that the AV is on the coverage lane, controlling, with the computer system, the AV to maintain at least one functionality associated with the fully-autonomous mode.

In some non-limiting embodiments or aspects, the method further includes determining, based on the map data with the computer system, that the AV has transitioned from the coverage lane to the AV lane; and in response to determining that that the AV has transitioned from the coverage lane to the AV lane, controlling the AV to enter the fully-autonomous mode.

In some non-limiting embodiments or aspects, the method further includes detecting, with one or more sensors, sensor data associated with an object in an environment surrounding the AV; and controlling, with the computer system, the AV to maintain the at least one functionality associated with the fully-autonomous mode in the coverage lane based on the sensor data from the one or more sensors and the map data.

In some non-limiting embodiments or aspects, the one or more sensors include a light detection and ranging (LIDAR) system, the map data includes map point data associated with a location of a number of points that correspond to objects that have reflected a ranging laser during one or more traversals of the coverage lane by one or more mapping AVs, and the method further includes determining, with the LIDAR system, sensor point data associated with a location of a number of points that correspond to objects within the environment of the AV; and controlling, with the computer system, the AV to maintain the at least one functionality associated with the fully-autonomous mode to determine a position of the AV in the coverage lane based on the sensor point data and the map point data.

In some non-limiting embodiments or aspects, the map data is associated with a location of a number of points that correspond to objects that have reflected a ranging laser during one or more traversals of the coverage lane by one or more mapping AVs.

In some non-limiting embodiments or aspects, the at least one functionality associated with the fully-autonomous mode determines operation data in the coverage lane, and the method further includes controlling, with the computer system, the AV to perform the at least one functionality in the fully-autonomous mode in the AV lane based on the operation data determined in the coverage lane.

In some non-limiting embodiments or aspects, the map data is associated with a link between the AV lane and the coverage lane of the roadway, and the method further includes determining, with a positioning system, positioning data associated with a position of the AV; determining, with the computer system, a position of the AV with respect to the link between the AV lane and the coverage lane based on the positioning data and the map data; and controlling, with the computer system, the AV to maintain the at least one functionality associated with the fully-autonomous mode in the coverage lane based on the position of the AV with respect to the link between the AV lane and the coverage lane.

According to some non-limiting embodiments or aspects, provided is a computing system including one or more processors configured to: receive map data associated with a map of a geographic location, the map including (i) a coverage lane where an autonomous vehicle (AV) can operate and/or travel under a partially-autonomous mode or a manual mode, and (ii) an AV lane where the AV can operate and/or travel under a fully-autonomous mode, wherein the coverage lane is linked to the AV lane; determine, based on the map data, that the AV is on the coverage lane; and in response to determining that the AV is on the coverage lane, control the AV to maintain at least one functionality associated with the fully-autonomous mode.

In some non-limiting embodiments or aspects, the one or more processors are further configured to: determine, based on the map data, that the AV has transitioned from the coverage lane to the AV lane; and in response to determining that that the AV has transitioned from the coverage lane to the AV lane, control the AV to enter the fully-autonomous mode.

In some non-limiting embodiments or aspects, the system further includes one or more sensors configured to detect an object in an environment surrounding the AV, and the one or more processors are further configured to control the AV to maintain the at least one functionality associated with the fully-autonomous mode in the coverage lane based on sensor data from the one or more sensors and the map data.

In some non-limiting embodiments or aspects, the one or more sensors include a light detection and ranging (LIDAR) system, the LIDAR system is configured to determine sensor point data associated with a location of a number of points that correspond to objects within the environment of the AV, the map data includes map point data associated with a location of a number of points that correspond to objects that have reflected a ranging laser during one or more traversals of the coverage lane by one or more mapping AVs, and the one or more processors are further configured to control the AV to maintain the at least one functionality associated with the fully-autonomous mode to determine a position of the AV in the coverage lane based on the sensor point data and the map point data.

In some non-limiting embodiments or aspects, the at least one functionality associated with the fully-autonomous mode determines operation data in the coverage lane, and the one or more processors are further configured to control the AV to perform the at least one functionality in the fully-autonomous mode in the AV lane based on the operation data determined in the coverage lane.

In some non-limiting embodiments or aspects, the system further includes a positioning system configured to determine a position of the AV, the map data is associated with a link between the AV lane and the coverage lane, and the one or more processors are further configured to: determine the position of the AV with respect to the link between the AV lane and the coverage lane based on positioning data from the positioning system and the map data; and control the AV to maintain the at least one functionality associated with the fully-autonomous mode in the coverage lane based on the position of the AV with respect to the link between the AV lane and the coverage lane.

Further non-limiting embodiments or aspects are set forth in the following numbered clauses:

Clause 1. An autonomous vehicle (AV) comprising: a vehicle computing system comprising one or more processors, wherein the vehicle computing system is configured to: receive map data associated with a map of a geographic location, the map comprising (i) a coverage lane where the AV can operate and/or travel under a partially-autonomous mode or a manual mode, and (ii) an AV lane where the AV can operate and/or travel under a fully-autonomous mode, wherein the coverage lane is linked to the AV lane; determine, based on the map data, that the AV is on the coverage lane; and in response to determining that the AV is on the coverage lane, control the AV to maintain at least one functionality associated with the fully-autonomous mode.

Clause 2. The AV of clause 1, wherein the vehicle computing system is further configured to: determine, based on the map data, that the AV has transitioned from the coverage lane to the AV lane; and in response to determining that that the AV has transitioned from the coverage lane to the AV lane, control the AV to enter the fully-autonomous mode.

Clause 3. The AV of any of clauses 1 and 2, further comprising: one or more sensors configured to detect an object in an environment surrounding the AV, wherein the vehicle computing system is further configured to: control the AV to maintain the at least one functionality associated with the fully-autonomous mode in the coverage lane based on sensor data from the one or more sensors and the map data.

Clause 4. The AV of any of clauses 1-3, wherein the one or more sensors include a light detection and ranging (LIDAR) system, wherein the LIDAR system is configured to determine sensor point data associated with a location of a number of points that correspond to objects within the environment of the AV, wherein the map data includes map point data associated with a location of a number of points that correspond to objects that have reflected a ranging laser during one or more traversals of the coverage lane location by one or more mapping AVs, and wherein the vehicle computing system is further configured to: control the AV to maintain the at least one functionality associated with the fully-autonomous mode to determine a position of the AV in the coverage lane based on the sensor point data and the map point data.

Clause 5. The AV of any of clauses 1-4, wherein the map data is associated with a location of a number of points that correspond to objects that have reflected a ranging laser during one or more traversals of the coverage lane by one or more mapping AVs.

Clause 6. The AV of any of clauses 1-5, wherein the at least one functionality associated with the fully-autonomous mode determines operation data in the coverage lane, and wherein the vehicle computing system is further configured to: control the AV to perform the at least one functionality in the AV lane in the fully-autonomous mode based on the operation data determined in the coverage lane.

Clause 7. The AV of any of clauses 1-6, wherein the map data is associated with a link between the AV lane and the coverage lane, the AV further comprising: a positioning system configured to determine a position of the AV, wherein the vehicle computing system is further configured to: determine the position of the AV with respect to the link between the AV lane and the coverage lane based on positioning data from the positioning system and the map data; and control the AV to maintain the at least one functionality associated with the fully-autonomous mode in the coverage lane based on the position of the AV with respect to the link between the AV lane and the coverage lane.

Clause 8. A method comprising: receiving, with a computer system comprising one or more processors, map data associated with a map of a geographic location, the map comprising (i) a coverage lane where an autonomous vehicle (AV) can operate and/or travel under a partially-autonomous mode or a manual mode, and (ii) an AV lane where the AV can operate and/or travel under a fully-autonomous mode, wherein the coverage lane is linked to the AV lane; determining, based on the map data with the computer system, that the AV is on the coverage lane; and in response to determining that the AV is on the coverage lane, controlling, with the computer system, the AV to maintain at least one functionality associated with the fully-autonomous mode.

Clause 9. The method of clause 8, further comprising: determining, based on the map data with the computer system, that the AV has transitioned from the coverage lane to the AV lane; and in response to determining that that the AV has transitioned from the coverage lane to the AV lane, controlling the AV to enter the fully-autonomous mode.

Clause 10. The method of any of clauses 8 and 9, further comprising: detecting, with one or more sensors, sensor data associated with an object in an environment surrounding the AV; and controlling, with the computer system, the AV to maintain the at least one functionality associated with the fully-autonomous mode in the coverage lane based on the sensor data from the one or more sensors and the map data.

Clause 11. The method of any of clauses 8-10 wherein the one or more sensors include a light detection and ranging (LIDAR) system, and wherein the map data includes map point data associated with a location of a number of points that correspond to objects that have reflected a ranging laser during one or more traversals of the coverage lane by one or more mapping AVs, the method further comprising: determining, with the LIDAR system, sensor point data associated with a location of a number of points that correspond to objects within the environment of the AV; and controlling, with the computer system, the AV to maintain the at least one functionality associated with the fully-autonomous mode to determine a position of the AV in the coverage lane based on the sensor point data and the map point data.

Clause 12. The method of any of clauses 8-11, wherein the map data is associated with a location of a number of points that correspond to objects that have reflected a ranging laser during one or more traversals of the coverage lane by one or more mapping AVs.

Clause 13. The method of any of clauses 8-12, wherein the at least one functionality associated with the fully-autonomous mode determines operation data in the coverage lane, the method further comprising: controlling, with the computer system, the AV to perform the at least one functionality in the fully-autonomous mode in the AV lane based on the operation data determined in the coverage lane.

Clause 14. The method of any of clauses 8-13, wherein the map data is associated with a link between the AV lane and the coverage lane of the roadway, the method further comprising: determining, with a positioning system, positioning data associated with a position of the AV; determining, with the computer system, a position of the AV with respect to the link between the AV lane and the coverage lane based on the positioning data and the map data; and controlling, with the computer system, the AV to maintain the at least one functionality associated with the fully-autonomous mode in the coverage lane based on the position of the AV with respect to the link between the AV lane and the coverage lane.

Clause 15. A computing system comprising: one or more processors configured to: receive map data associated with a map of a geographic location, the map comprising (i) a coverage lane where the AV can operate and/or travel under a partially-autonomous mode or a manual mode, and (ii) an AV lane where the AV can operate and/or travel under a fully-autonomous mode, wherein the coverage lane is linked to the AV lane; determine, based on the map data, that the AV is on the coverage lane; and in response to determining that the AV is on the coverage lane, control the AV to maintain at least one functionality associated with the fully-autonomous mode.

Clause 16. The system of clause 15, wherein the one or more processors are further configured to: determine, based on the map data, that the AV has transitioned from the coverage lane to the AV lane; and in response to determining that that the AV has transitioned from the coverage lane to the AV lane, control the AV to enter the fully-autonomous mode.

Clause 17. The system of any of clauses 15 and 16, further comprising: one or more sensors configured to detect an object in an environment surrounding the AV, wherein the one or more processors are further configured to control the AV to maintain the at least one functionality associated with the fully-autonomous mode in the coverage lane based on sensor data from the one or more sensors and the map data.

Clause 18. The system of any of clauses 15-17, wherein the one or more sensors include a light detection and ranging (LIDAR) system, wherein the LIDAR system is configured to determine sensor point data associated with a location of a number of points that correspond to objects within the environment of the AV, wherein the map data includes map point data associated with a location of a number of points that correspond to objects that have reflected a ranging laser during one or more traversals of the coverage lane by one or more mapping AVs, and wherein the one or more processors are further configured to control the AV to maintain the at least one functionality associated with the fully-autonomous mode to determine a position of the AV in the coverage lane based on the sensor point data and the map point data.

Clause 19. The system of any of clauses 15-18, wherein the at least one functionality associated with the fully-autonomous mode determines operation data in the coverage lane, and wherein the one or more processors are further configured to control the AV to perform the at least one functionality in the fully-autonomous mode in the AV lane based on the operation data determined in the coverage lane.

Clause 20. The system of any of clauses 15-19, further comprising: a positioning system configured to determine a position of the AV, wherein the map data is associated with a link between the AV lane and the coverage lane, wherein the one or more processors are further configured to: determine the position of the AV with respect to the link between the AV lane and the coverage lane based on positioning data from the positioning system and the map data; and control the AV to maintain the at least one functionality associated with the fully-autonomous mode in the coverage lane based on the position of the AV with respect to the link between the AV lane and the coverage lane.

### BRIEF DESCRIPTION OF THE DRAWINGS

FIG. 1 is a diagram of a non-limiting embodiment of an environment in which systems and/or methods, described herein, can be implemented;

FIG. 2 is a diagram of a non-limiting embodiment of a system for controlling an autonomous vehicle shown in FIG. 1;

FIG. 3 is a diagram of a non-limiting embodiment of components of one or more devices of FIGS. 1 and 2;

FIG. 4 is a flowchart of a non-limiting embodiment of a process for controlling an autonomous vehicle; and

FIGS. 5A-5D are diagrams of an implementation of a non-limiting embodiment of a process disclosed herein.

### DETAILED DESCRIPTION

The following detailed description of non-limiting embodiments refers to the accompanying drawings. The same reference numbers in different drawings may identify the same or similar elements.

In some non-limiting embodiments, a map of a geographic location is used for controlling travel of an autonomous vehicle (AV) on roadways specified in the map. For example, the AV travels autonomously (e.g., in a fully-autonomous mode) in one or more AV lanes on one or more roadway segments between a pick-up location (or a current location) and a destination location based on the map.

However, a map (e.g., a map, one or more submaps of a map, etc.) may include lanes on roadway segments in which an AV can be operated, routed and/or travel in or under a partially-autonomous mode or a manual mode (e.g., lanes on roadway segments in which an AV cannot be operated, routed and/or travel in or under the fully-autonomous mode). For example, the AV may be operated, routed and/or travel in an AV lane in which the AV can operate and/or travel in or under the fully-autonomous mode and in a coverage lane in which the AV can be operated, routed, and/or travel in or under the partially-autonomous mode or the manual mode. In some non-limiting embodiments, a functionality associated with the fully-autonomous mode (e.g., with fully-autonomous operation of the AV performed during fully-autonomous travel of the AV) is not performed in the partially-autonomous mode or the manual mode (e.g., during partially-autonomous or manual, non-autonomous operation and/or travel of the AV). For example, some functionalities associated with the fully-autonomous mode and/or systems associated with control of fully-autonomous operation and/or travel of the AV in or under the fully-autonomous mode may not be performed during operation and/or travel of the AV in or under the partially-autonomous mode or the manual mode. As an example, higher resolution localization operations and/or systems, such as localization functions and systems that use light detection and ranging (LIDAR) point clouds and/or precise pose positioning techniques, may not be available for operation or travel of the AV in a coverage lane under the partially-autonomous mode or the manual mode. In this way, an AV may experience a processing delay (e.g., several seconds of processing time) associated with transitioning from the partially-autonomous mode or the manual mode (e.g., from partially-autonomous travel or manual, non-autonomous travel) to the fully-autonomous mode (e.g., fully-autonomous travel) based on an initialization time, a boot time, a bootstrapping time, and/or the like associated with a functionality and/or system of the fully-autonomous mode initializing, booting, bootstrapping and/or the like before fully-autonomous operation and/or travel of the AV can begin.

As disclosed herein, in some non-limiting embodiments, an AV includes a vehicle computing system including one or more processors that receive map data associated with a map of a geographic location. The map includes (i) a coverage lane where the AV can operate and/or travel under a partially-autonomous mode or a manual mode, and (ii) an AV lane where the AV can operate and/or travel under a fully-autonomous mode, wherein the coverage lane is linked to the AV lane. The vehicle computing system determines, based on the map data, that the AV is on the coverage lane and, in response to determining that the AV is on the coverage lane, controls the AV to maintain at least one functionality associated with the fully-autonomous mode. In this way, the vehicle computing system maintains the functionality associated with the fully-autonomous mode (e.g., continues processing and/or execution of the functionality or system) in the coverage lane under the partially-autonomous mode or the manual mode (e.g., during partially-autonomous operation and/or travel or manual, non-autonomous operation and/or travel of the AV in the coverage lane). Accordingly, the vehicle computing system reduces or eliminates a processing delay associated with transitioning from the partially-autonomous mode or the manual mode to the fully-autonomous mode (e.g., from partially-autonomous travel or manual, non-autonomous travel of the AV in the coverage lane to fully-autonomous travel of the AV in the AV lane). For example, the vehicle computing system reduces or eliminates an initialization time, a boot time, a bootstrapping time, and/or the like associated with a functionality and/or system of the fully-autonomous mode initializing, booting, bootstrapping and/or the like before fully-autonomous operation and/or travel can begin by maintaining and/or continuing processing and/or execution of the functionality or system in the partially-autonomous mode or the manual mode during partially-autonomous operation and/or travel or manual, non-autonomous operation and/or travel of the AV in the coverage lane.

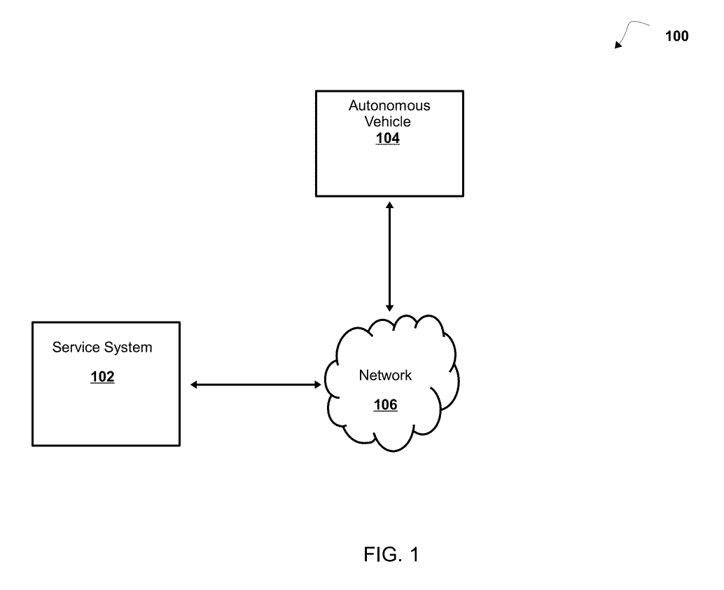

Referring now to FIG. 1, FIG. 1 is a diagram of a non-limiting embodiment of an environment 100 in which systems and/or methods, described herein, can be implemented. As shown in FIG. 1, environment 100 includes service system 102, autonomous vehicle 104, and network 106. Systems and/or devices of environment 100 can interconnect via wired connections, wireless connections, or a combination of wired and wireless connections.

In some non-limiting embodiments, service system 102, such as a service platform for providing services for an application platform, such as a transportation platform, a ride sharing platform, a delivery service platform, a courier service platform, or the like, includes one or more devices capable of communicating with a user device to provide user access to an application platform. As an example, service system 102 communicates with autonomous vehicle 104 to provision services associated with an application platform, such as a transportation platform, a ride sharing platform, a delivery service platform, a courier service platform, and/or other service platforms. In some non-limiting embodiments, service system 102 is associated with a central operations system and/or an entity associated with autonomous vehicle 104 and/or an application platform such as, for example, an AV owner, an AV manager, a fleet operator, a service provider, and/or the like.

In some non-limiting embodiments, service system 102 includes a map generation system as described in related U.S. application Ser. No. 15/903,399, assigned to the assignee of the present disclosure and filed concurrently herewith on Feb. 23, 2018 which claims the benefit of U.S. Provisional Application No. 62/582,731, filed Nov. 7, 2017, the entire disclosure of which is hereby incorporated by reference in its entirety.

In some non-limiting embodiments, service system 102 and/or autonomous vehicle 104 include one or more devices capable of receiving, storing, and/or providing map data (e.g., map data, AV map data, coverage map data, hybrid map data, submap data, etc.) associated with a map (e.g., a map, a submap, an AV map, a coverage map, a hybrid map, etc.) of a geographic location (e.g., a country, a state, a city, a portion of a city, a township, a portion of a township, etc.). For example, maps are used for routing autonomous vehicle 104 on a roadway specified in the map.

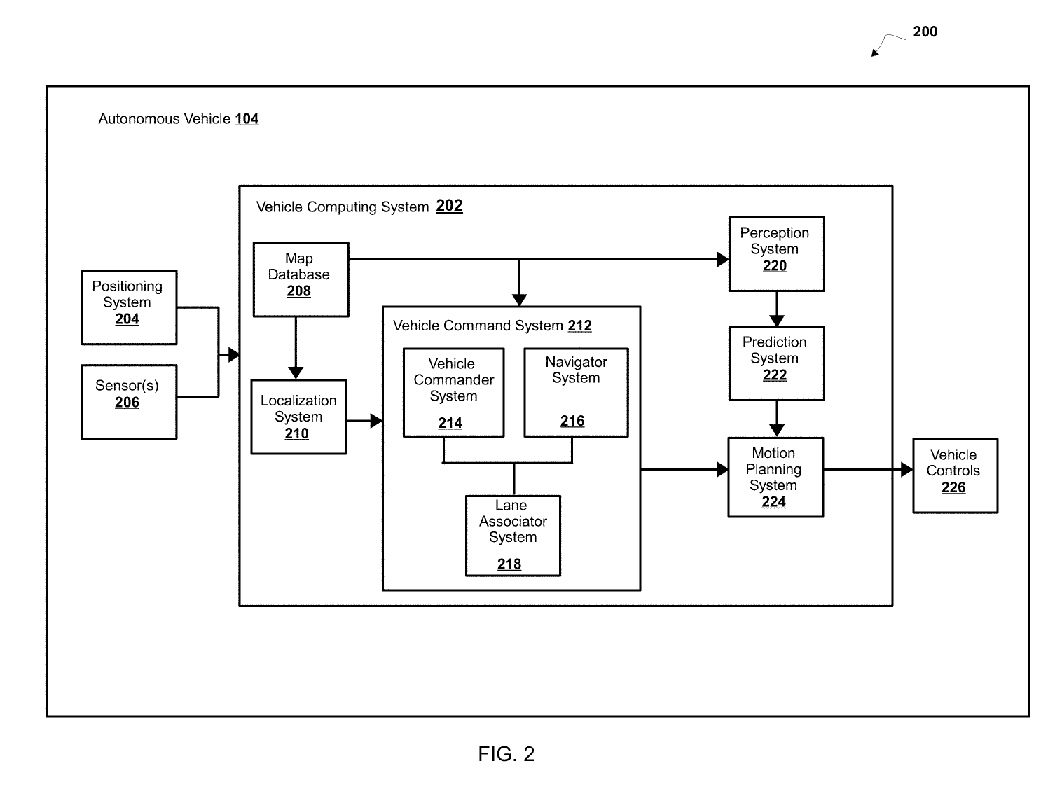

In some non-limiting embodiments, autonomous vehicle 104 includes one or more devices capable of receiving map data associated with a map of a geographic location, determining, based on the map data, that autonomous vehicle 104 is on a coverage lane, and, in response to determining that the AV is on the coverage lane, controlling the AV to maintain at least one functionality associated with a fully-autonomous mode. For example, autonomous vehicle 104 can include one or more computing systems including one or more processors (e.g., one or more servers, etc.). Further details regarding non-limiting embodiments of autonomous vehicle 104 are provided below with regard to FIG. 2.

In some non-limiting embodiments, network 106 includes one or more wired and/or wireless networks. For example, network 106 includes a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems, devices, and networks shown in FIG. 1 are provided as an example. There can be additional systems, devices and/or networks, fewer systems, devices, and/or networks, different systems, devices and/or networks, or differently arranged systems, devices, and/or networks than those shown in FIG. 1. Furthermore, two or more systems or devices shown in FIG. 1 can be implemented within a single system or a single device, or a single system or a single device shown in FIG. 1 can be implemented as multiple, distributed systems or devices. Additionally, or alternatively, a set of systems or a set of devices (e.g., one or more systems, one or more devices) of environment 100 can perform one or more functions described as being performed by another set of systems or another set of devices of environment 100.

Referring now to FIG. 2, FIG. 2 is a diagram of a non-limiting embodiment of a system 200 for controlling autonomous vehicle 104. As shown in FIG. 2, vehicle computing system 202 includes vehicle command system 212, perception system 220, prediction system 222, and motion planning system 224 that cooperate to perceive a surrounding environment of autonomous vehicle 104, determine a motion plan and control the motion (e.g., the direction of travel) of autonomous vehicle 104 accordingly.

In some non-limiting embodiments, vehicle computing system 202 is connected to or includes positioning system 204. In some non-limiting embodiments, positioning system 204 determines a position (e.g., a current position, a past position, etc.) of autonomous vehicle 104. In some non-limiting embodiments, positioning system 204 determines a position of autonomous vehicle 104 based on an inertial sensor, a satellite positioning system, an IP address (e.g., an IP address of autonomous vehicle 104, an IP address of a device in autonomous vehicle 104, etc.), triangulation based on network components (e.g., network access points, cellular towers, Wi-Fi access points, etc.), and/or proximity to network components, and/or the like. In some non-limiting embodiments, the position of autonomous vehicle 104 is used by vehicle computing system 202.

In some non-limiting embodiments, vehicle computing system 202 receives sensor data from one or more sensors 206 that are coupled to or otherwise included in autonomous vehicle 104. For example, one or more sensors 206 includes a LIDAR system, a Radio Detection and Ranging (RADAR) system, one or more cameras (e.g., visible spectrum cameras, infrared cameras, etc.), and/or the like. In some non-limiting embodiments, the sensor data includes data that describes a location of objects within the surrounding environment of the autonomous vehicle 104. In some non-limiting embodiments, one or more sensors 206 collect sensor data that includes data that describes a location (e.g., in three-dimensional space relative to the autonomous vehicle 104) of points that correspond to objects within the surrounding environment of autonomous vehicle 104.

In some non-limiting embodiments, the sensor data includes a location (e.g., a location in three-dimensional space relative to the LIDAR system) of a number of points (e.g., a point cloud) that correspond to objects that have reflected a ranging laser. In some non-limiting embodiments, the LIDAR system measures distances by measuring a Time of Flight (TOF) that a short laser pulse takes to travel from a sensor of the LIDAR system to an object and back, and the LIDAR system calculates the distance of the object to the LIDAR system based on the known speed of light. In some non-limiting embodiments, map data includes LIDAR point cloud maps associated with a geographic location (e.g., a location in three-dimensional space relative to the LIDAR system of a mapping vehicle) of a number of points (e.g., a point cloud) that correspond to objects that have reflected a ranging laser of one or more mapping vehicles at the geographic location. As an example, a map can include a LIDAR point cloud layer that represents objects and distances between objects in the geographic location of the map.

In some non-limiting embodiments, the sensor data includes a location (e.g., a location in three-dimensional space relative to the RADAR system) of a number of points that correspond to objects that have reflected a ranging radio wave. In some non-limiting embodiments, radio waves (e.g., pulsed radio waves or continuous radio waves) transmitted by the RADAR system can reflect off an object and return to a receiver of the RADAR system. The RADAR system can then determine information about the object's location and/or speed. In some non-limiting embodiments, the RADAR system provides information about the location and/or the speed of an object relative to the RADAR system based on the radio waves.

In some non-limiting embodiments, image processing techniques (e.g., range imaging techniques such as, for example, structure from motion, structured light, stereo triangulation, etc.) can be performed by system 200 to identify a location (e.g., in three-dimensional space relative to the one or more cameras) of a number of points that correspond to objects that are depicted in images captured by one or more cameras. Other sensors can identify the location of points that correspond to objects as well.

In some non-limiting embodiments, map database 208 provides detailed information associated with the map, features of the roadway in the geographic location, and information about the surrounding environment of the autonomous vehicle 104 for the autonomous vehicle to use while driving (e.g. traversing a route, planning a route, determining a motion plan, controlling the autonomous vehicle, etc.).

In some non-limiting embodiments, vehicle computing system 202 receives a vehicle pose from localization system 210 based on one or more sensors 206 that are coupled to or otherwise included in autonomous vehicle 104. In some non-limiting embodiments, the localization system 210 includes a LIDAR localizer, a low quality pose localizer, and/or a pose filter. For example, the localization system uses a pose filter that receives and/or determines one or more valid pose estimates (e.g. not based on invalid position data, etc.) from the LIDAR localizer and/or the low quality pose localizer, for determining a map-relative vehicle pose. For example, low quality pose localizer determines a low quality pose estimate in response to receiving position data from positioning system 204 for operating (e.g., routing, navigating, controlling, etc.) the autonomous vehicle 104 under manual control (e.g. in a coverage lane). In some non-limiting embodiments, LIDAR localizer determines a LIDAR pose estimate in response to receiving sensor data (e.g. LIDAR data, RADAR data, etc.) from sensors 206 for operating (e.g., routing, navigating, controlling, etc.) the autonomous vehicle 104 under autonomous control (e.g. in an AV lane).

In some non-limiting embodiments vehicle command system 212 includes vehicle commander system 214, navigator system 216, and lane associator system 218 that cooperate to route and/or navigate the autonomous vehicle 104 in a geographic location. In some non-limiting embodiments, vehicle commander system 214 provides tracking of a current objective of the autonomous vehicle 104, including a current service, a target pose, and/or a coverage plan (e.g. development testing, etc.). In some non-limiting embodiments, navigator system 216 determines and/or provides a route plan for the autonomous vehicle 104 based on the current state of the autonomous vehicle 104, map data (e.g. lane graph, etc.), and one or more vehicle commands (e.g. a target pose). For example, navigator system 216 determines a route plan (e.g., plan, re-plan, deviation, etc.) including one or more lanes (e.g., current lane, future lane, etc.) in one or more roadways that the autonomous vehicle 104 may traverse on a route to a destination (e.g. target, trip drop-off, etc.).

In some non-limiting embodiments, navigator system 216 determines a route plan based on one or more lanes received from lane associator system 218. In some non-limiting embodiments, lane associator determines one or more lanes of a route in response to receiving a vehicle pose from the localization system 210. For example, the lane associator system 218 determines, based on the vehicle pose, that the AV is on a coverage lane, and in response to determining that the AV is on the coverage lane, determines one or more candidate lanes (e.g. routable lanes) within a distance of the vehicle pose associated with the autonomous vehicle 104. For example, the lane associator 218 determines, based on the vehicle pose, that the AV is on an AV lane, and in response to determining that the AV is on the AV lane, determines one or more candidate lanes (e.g. routable lanes) within a distance of the vehicle pose associated with the autonomous vehicle 104. In some non-limiting embodiments, navigator system 216 generates a cost function for each of one or more candidate lanes the autonomous vehicle may traverse on a route to a destination. For example, navigator system 216 generates the cost function that describes a cost (e.g., a cost over a time period) of following (e.g., adhering to) one or more lanes that may be used to reach a target pose.

In some non-limiting embodiments, perception system 220 detects and/or tracks objects (e.g., vehicles, pedestrians, bicycles, and the like) that are proximate to (e.g., in proximity to the surrounding environment of) the autonomous vehicle 104 over a time period. In some non-limiting embodiments, perception system 220 can retrieve (e.g., obtain) map data from map database 208 that provides detailed information about the surrounding environment of the autonomous vehicle 104.

In some non-limiting embodiments, perception system 220 determines one or more objects that are proximate to autonomous vehicle 104 based on sensor data received from one or more sensors 206 and/or map data from map database 208. For example, perception system 220 determines, for the one or more objects that are proximate, state data associated with a state of such object. In some non-limiting embodiments, the state data associated with an object includes data associated with a location of the object (e.g., a position, a current position, an estimated position, etc.), data associated with a speed of the object (e.g., a magnitude of velocity of the object), data associated with a direction of travel of the object (e.g., a heading, a current heading, etc.), data associated with an acceleration rate of the object (e.g., an estimated acceleration rate of the object, etc.), data associated with an orientation of the object (e.g., a current orientation, etc.), data associated with a size of the object (e.g., a size of the object as represented by a bounding shape such as a bounding polygon or polyhedron, a footprint of the object, etc.), data associated with a type of the object (e.g., a class of the object, an object with a type of vehicle, an object with a type of pedestrian, an object with a type of bicycle, etc.), and/or the like.

In some non-limiting embodiments, perception system 220 determines state data for an object over a number of iterations of determining state data. For example, perception system 220 updates the state data for each object of a plurality of objects during each iteration.

In some non-limiting embodiments, prediction system 222 receives the state data associated with one or more objects from perception system 220. Prediction system 222 predicts one or more future locations for the one or more objects based on the state data. For example, prediction system 222 predicts the future location of each object of a plurality of objects within a time period (e.g., 5 seconds, 10 seconds, 20 seconds, etc.). In some non-limiting embodiments, prediction system 222 predicts that an object will adhere to the object's direction of travel according to the speed of the object. In some non-limiting embodiments, prediction system 222 uses machine learning techniques or modeling techniques to make a prediction based on state data associated with an object.

In some non-limiting embodiments, motion planning system 224 determines a motion plan for autonomous vehicle 104 based on a prediction of a location associated with an object provided by prediction system 222 and/or based on state data associated with the object provided by perception system 220. For example, motion planning system 224 determines a motion plan (e.g., an optimized motion plan) for the autonomous vehicle 104 that causes autonomous vehicle 104 to travel relative to the object based on the prediction of the location for the object provided by prediction system 222 and/or the state data associated with the object provided by perception system 220.

In some non-limiting embodiments, motion planning system 224 receives a route plan as a command from the navigator system 216. In some non-limiting embodiments, motion planning system 224 determines a cost function for each of one or more motion plans of a route for autonomous vehicle 104 based on the locations and/or predicted locations of one or more objects. For example, motion planning system 224 determines the cost function that describes a cost (e.g., a cost over a time period) of following (e.g., adhering to) a motion plan (e.g., a selected motion plan, an optimized motion plan, etc.). In some non-limiting embodiments, the cost associated with the cost function increases and/or decreases based on autonomous vehicle 104 deviating from a motion plan (e.g., a selected motion plan, an optimized motion plan, a preferred motion plan, etc.). For example, the cost associated with the cost function increases and/or decreases based on autonomous vehicle 104 deviating from the motion plan to avoid a collision with an object.

In some non-limiting embodiments, motion planning system 224 determines a cost of following a motion plan. For example, motion planning system 224 determines a motion plan for autonomous vehicle 104 based on one or more cost functions. In some non-limiting embodiments, motion planning system 224 determines a motion plan (e.g., a selected motion plan, an optimized motion plan, a preferred motion plan, etc.) that minimizes a cost function. In some non-limiting embodiments, motion planning system 224 provides a motion plan to vehicle controls 226 (e.g., a device that controls acceleration, a device that controls steering, a device that controls braking, an actuator that controls gas flow, etc.) to implement the motion plan.

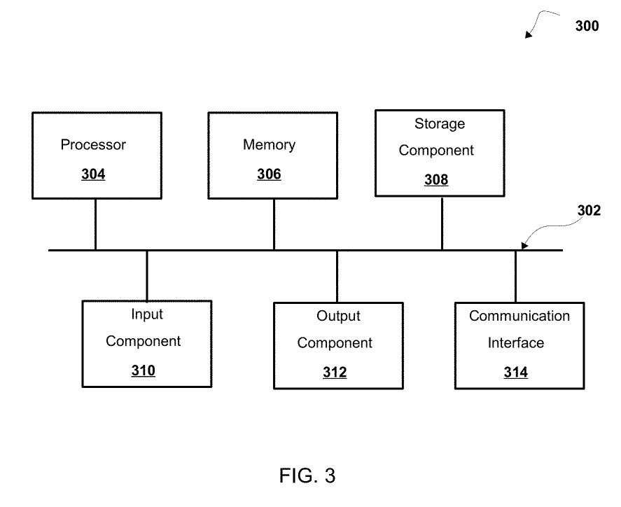

Referring now to FIG. 3, FIG. 3 is a diagram of example components of a device 300. Device 300 can correspond to one or more devices of service system 102 and/or one or more devices (e.g., one or more devices of a system) of autonomous vehicle 104. In some non-limiting embodiments, one or more devices of service system 102 and/or one or more devices (e.g., one or more devices of a system of) autonomous vehicle 104 can include at least one device 300 and/or at least one component of device 300. As shown in FIG. 3, device 300 includes bus 302, processor 304, memory 306, storage component 308, input component 310, output component 312, and communication interface 314.

Bus 302 includes a component that permits communication among the components of device 300. In some non-limiting embodiments, processor 304 is implemented in hardware, firmware, or a combination of hardware and software. For example, processor 304 includes a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 306 includes a random access memory (RAM), a read only memory (ROM), and/or another type of dynamic or static storage device (e.g., flash memory, magnetic memory, optical memory, etc.) that stores information and/or instructions for use by processor 304.

Storage component 308 stores information and/or software related to the operation and use of device 300. For example, storage component 308 includes a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 310 includes a component that permits device 300 to receive information, such as via user input (e.g., a touch screen display, a keyboard, a keypad, a mouse, a button, a switch, a microphone, etc.). Additionally, or alternatively, input component 310 includes a sensor for sensing information (e.g., a global positioning system (GPS) component, an accelerometer, a gyroscope, an actuator, etc.). Output component 312 includes a component that provides output information from device 300 (e.g., a display, a speaker, one or more light-emitting diodes (LEDs), etc.).

Communication interface 314 includes a transceiver-like component (e.g., a transceiver, a separate receiver and transmitter, etc.) that enables device 300 to communicate with other devices, such as via a wired connection, a wireless connection, or a combination of wired and wireless connections. Communication interface 314 can permit device 300 to receive information from another device and/or provide information to another device. For example, communication interface 314 includes an Ethernet interface, an optical interface, a coaxial interface, an infrared interface, a radio frequency (RF) interface, a universal serial bus (USB) interface, a Wi-Fi interface, a cellular network interface, and/or the like.

Device 300 can perform one or more processes described herein. Device 300 can perform these processes based on processor 304 executing software instructions stored by a computer-readable medium, such as memory 306 and/or storage component 308. A computer-readable medium (e.g., a non-transitory computer-readable medium) is defined herein as a non-transitory memory device. A memory device includes memory space located inside of a single physical storage device or memory space spread across multiple physical storage devices.

Software instructions can be read into memory 306 and/or storage component 308 from another computer-readable medium or from another device via communication interface 314. When executed, software instructions stored in memory 306 and/or storage component 308 cause processor 304 to perform one or more processes described herein. Additionally, or alternatively, hardwired circuitry can be used in place of or in combination with software instructions to perform one or more processes described herein. Thus, embodiments described herein are not limited to any specific combination of hardware circuitry and software.

The number and arrangement of components shown in FIG. 3 are provided as an example. In some non-limiting embodiments, device 300 includes additional components, fewer components, different components, or differently arranged components than those shown in FIG. 3. Additionally, or alternatively, a set of components (e.g., one or more components) of device 300 can perform one or more functions described as being performed by another set of components of device 300.

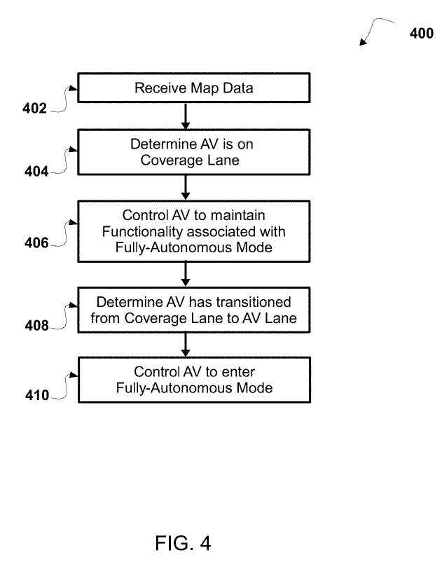

Referring now to FIG. 4, FIG. 4 is a flowchart of a non-limiting embodiment of a process 400 for controlling an AV. In some non-limiting embodiments, one or more of the steps of process 400 are performed (e.g., completely, partially, etc.) by autonomous vehicle 104 (e.g., one or more devices of autonomous vehicle 104). In some non-limiting embodiments, one or more of the steps of process 400 are performed (e.g., completely, partially, etc.) by another device or a group of devices separate from or including autonomous vehicle 104, such as service system 102 (e.g., one or more devices of service system 102).

As shown in FIG. 4, at step 402, process 400 includes receiving map data associated with a map of a geographic location. For example, autonomous vehicle 104 (e.g., vehicle computing system 202, etc.) receives map data associated with a map of a geographic location from service system 102 and/or a database (e.g., a database associated with service system 102, a database located in service system 102, a database remote from service system 102, a database associated with autonomous vehicle 104, a database located in autonomous vehicle 104 (e.g., map database 208, etc.), a database remote from autonomous vehicle 104, etc.). In some non-limiting embodiments, the map includes (i) the coverage lane where the autonomous vehicle 104 can operate and/or travel under a partially-autonomous mode or a manual mode, and (ii) an AV lane where the autonomous vehicle 104 can operate and/or travel under the fully-autonomous mode, and the coverage lane is linked to the AV lane.

In some non-limiting embodiments, map data includes data associated with a road (e.g., an identity and/or a location of a roadway of a road, an identity and/or location of a segment of a road, etc.), data associated with an object in proximity to a road (e.g., a building, a lamppost, a crosswalk, a curb of the road, etc.), data associated with a lane of a roadway (e.g., the location and/or direction of a travel lane, a parking lane, a turning lane, a bicycle lane, etc.), data associated with traffic control of a road (e.g., the location of and/or instructions associated with lane markings, traffic signs, traffic lights, etc.), and/or the like. In some non-limiting embodiments, a map of a geographic location includes one or more routes that include one or more roadways.

In some non-limiting embodiments, a road refers to a paved or otherwise improved path between two places that allows for travel by a vehicle (e.g., autonomous vehicle 104). Additionally, or alternatively, a road includes a roadway and a sidewalk in proximity to (e.g., adjacent, near, next to, touching, etc.) the roadway. In some non-limiting embodiments, a roadway includes a portion of road on which a vehicle is intended to travel and is not restricted by a physical barrier or by separation so that the vehicle is able to travel laterally. Additionally, or alternatively, a roadway (e.g., one or more roadway segments) includes one or more lanes, such as a travel lane (e.g., a lane upon which a vehicle travels, a traffic lane, etc.), a parking lane (e.g., a lane in which a vehicle parks), a bicycle lane (e.g., a lane in which a bicycle travels), a turning lane (e.g., a lane in which a vehicle turns from), and/or the like. In some non-limiting embodiments, a roadway is connected to another roadway, for example a lane of a roadway is connected to another lane of the roadway and/or a lane of the roadway is connected to a lane of another roadway.

In some non-limiting embodiments, a roadway is associated with map data (e.g., map data, AV map data, coverage map data, hybrid map data, submap data, etc.) that defines one or more roadway segments or extents of the roadway. For example, a roadway segment or extent can be connected or linked to another roadway segment or extent to form a roadway network, or a roadway network can be divided into roadways segments or extents. In some non-limiting embodiments, a roadway segment or extent is associated with one or more lanes (e.g., one or more AV lanes, one or more coverage lanes, one or more hybrid lanes, etc.), and the one or more lanes are associated with a directional indicator indicating a direction of travel in the one or more lanes of the roadway segment or extent.

In some non-limiting embodiments, a roadway is associated with map data (e.g., map data, AV map data, coverage map data, hybrid map data, submap data, etc.) that defines one or more attributes of (e.g., metadata associated with) the roadway (e.g., attributes of a roadway in a geographic location, attributes of a segment or extent of a roadway, attributes of a lane of a roadway, etc.). In some non-limiting embodiments, an attribute of a roadway includes a road edge of a road (e.g., a location of a road edge of a road, a distance of location from a road edge of a road, an indication whether a location is within a road edge of a road, etc.), an intersection, connection, or link of a road with another road, a roadway of a road, a distance of a roadway from another roadway (e.g., a distance of an end of a lane and/or a roadway segment or extent to an end of another lane and/or an end of another roadway segment or extent, etc.), a lane of a roadway of a road (e.g., a travel lane of a roadway, a parking lane of a roadway, a turning lane of a roadway, lane markings, a direction of travel in a lane of a roadway, etc.), one or more objects (e.g., a vehicle, vegetation, a pedestrian, a structure, a building, a sign, a lamppost, signage, a traffic sign, a bicycle, a railway track, a hazardous object, etc.) in proximity to and/or within a road (e.g., objects in proximity to the road edges of a road and/or within the road edges of a road), a sidewalk of a road, and/or the like. In some non-limiting embodiments, an attribute of a roadway includes one or more features of the roadway associated with one or more traversals of the roadway by one or more autonomous vehicles 104, a number of traversals of the roadway by one or more autonomous vehicles 104, a number of interventions associated with one or more traversals of the roadway by one or more autonomous vehicles 104, a number of objects (e.g., a number of hazards, a number of bicycles, a railway track in proximity to the roadway, etc.) associated with one or more traversals of the roadway by one or more autonomous vehicles 104, a distance (e.g., an average distance, a mile, etc.) associated with one or more traversals of the roadway by one or more autonomous vehicles 104 (e.g., a distance until a detection of a hazardous event, a distance until detection of a potentially harmful or a harmful event to an autonomous vehicle 104, to a rider of the autonomous vehicle 104, to a pedestrian, a distance between a first detection of a hazardous event and a second detection of a hazardous event, miles per harmful event, etc.), one or more traffic controls of the roadway associated with one or more traversals of the roadway by one or more autonomous vehicles 104, one or more aspects of the roadway (e.g., a dimension of one or more lanes of the roadway, a width of one or more lanes of the roadway, a number of bicycle lanes of the roadway, etc.) associated with one or more traversals of the roadway by one or more autonomous vehicles 104, a speed of one or more autonomous vehicles 104 associated with one or more traversals of the roadway by the one or more autonomous vehicles 104, and/or the like.

In some non-limiting embodiments, a lane of a roadway (and/or a roadway segment or extent) includes one or more ends. For example, an end of a lane (and/or an end of a roadway segment or extent) is associated with or corresponds to a geographic location at which map data associated with the lane (and/or the roadway segment or extent) is unavailable. As an example, an end of an AV lane can correspond to a geographic location at which map data for that lane ends (e.g., a geographic location at which map data associated with the AV lane of a roadway segment extent transitions from AV map data to coverage map data associated with a coverage lane of the roadway segment, to less detailed AV map data, to no AV map data, to no map data, etc.).

In some non-limiting embodiments, the map data includes a link (e.g., a logical link) that connects or links a lane (and/or a roadway segment or extent) to another lane (and/or to another roadway segment or extent). As an example, the map data includes a unique identifier for each lane (and/or roadway segment or extent), and the unique identifiers are associated with one another in the map data to indicate a connection or link of a lane to another lane (or a connection or link of a roadway segment or extent to another roadway segment or extent). For example, the unique identifiers can be associated with one another in the map data to indicate that a lane (and/or a roadway segment or extent) is a predecessor lane or a successor lane to another lane (and/or a predecessor or successor roadway segment or extent to another roadway segment or extent). As an example, a direction of travel of a predecessor lane to another lane is from the predecessor lane to the another lane, and a direction of travel of a successor lane to another lane is from the another lane to the successor lane.

In some non-limiting embodiments, AV map data is associated with an AV lane of a roadway in the geographic location, and the coverage map data is associated with a coverage lane of the roadway in the geographic location. In some non-limiting embodiments, the AV map data is associated with an indication that the autonomous vehicle 104 can operate in the AV lane under a fully-autonomous mode, and the coverage map data is associated with an indication that the autonomous vehicle 104 can operate in the coverage lane under a partially-autonomous mode or a manual mode. For example, an AV lane is associated with an indication that autonomous vehicle 104 can be operated, routed, and/or travel in or under a fully-autonomous mode in the AV lane (e.g., an indication that autonomous vehicle 104 can be routed to travel fully-autonomously and/or travel fully-autonomously in the AV lane), and a coverage lane is associated with an indication that autonomous vehicle 104 can be operated, routed, and/or travel in or under a partially-autonomous mode or a manual mode (e.g., an indication that autonomous vehicle 104 can be routed to travel partially-autonomously or manually and/or travel partially-autonomously or manually in the coverage lane, but cannot be routed to travel fully-autonomously and/or travel fully-autonomously in the coverage lane).

In some non-limiting embodiments, a map includes at least one of the following: an AV lane linked to another AV lane, an AV lane linked to a coverage lane, a coverage lane linked to another coverage lane, a hybrid lane linked between an AV lane and a coverage lane, and/or the like. In some non-limiting embodiments, a hybrid lane is associated with an indication that the autonomous vehicle 104 can operate and/or travel in the hybrid lane under the partially-autonomous mode or the manual mode, but not in the fully-autonomous mode. For example, a hybrid lane can be associated with coverage map data and may be represented as and/or include a coverage lane for operating, routing, and/or traveling functions of autonomous vehicle 104.

In some non-limiting embodiments, a map includes one or more AV lanes linked to one or more coverage lanes of one or more roadways in a geographic location. For example, a map includes one or more AV maps or submaps including one or more AV lanes linked to one or more coverage maps or submaps including one or more coverage lanes. In some non-limiting embodiments, an arbitrary number of coverage lanes is represented by a single coverage lane in a map. For example, as discussed herein, a coverage lane may not include as high of a level of detail as an AV lane (e.g., a coverage lane may not be associated with map data defining as high of a level of detail of attributes as an AV lane).

In some non-limiting embodiments, map data includes LIDAR point cloud maps (e.g., map point data, etc.) associated with a geographic location (e.g., a location in three-dimensional space relative to the LIDAR system of a mapping vehicle) of a number of points (e.g., a point cloud) that correspond to objects that have reflected a ranging laser of one or more mapping vehicles at the geographic location. As an example, a map can include a LIDAR point cloud layer that represents objects and distances between objects in the geographic location of a map.

In some non-limiting embodiments, a lane in which autonomous vehicle 104 can operate under the fully-autonomous mode (e.g., an AV lane) is associated with additional and/or alternative map data (e.g., additional or alternative attributes and/or roadway features) than another lane (e.g., a coverage lane or a hybrid lane) in which autonomous vehicle 104 cannot operate under the fully-autonomous mode. As an example, an AV lane in which autonomous vehicle 104 can operate under the fully-autonomous mode can be associated with map data including a more detailed and/or higher resolution map (e.g., a higher resolution point cloud), and a coverage lane in which autonomous vehicle 104 cannot operate under the fully-autonomous mode can be associated with coverage map data including a less detailed and/or lower resolution map (e.g., a lower resolution point cloud or no point cloud).

As further shown in FIG. 4, at step 404, process 400 includes determining, based on the map data, that the AV is on the coverage lane. For example, autonomous vehicle 104 (e.g., vehicle computing system 202, etc.) determines, based on the map data, that autonomous vehicle 104 is on the coverage lane.

In some non-limiting embodiments, autonomous vehicle 104 includes positioning system 204 that determines positioning data associated with a position of autonomous vehicle 104, and vehicle computing system 202 determines that autonomous vehicle 104 is on the AV lane (or the coverage lane) based on the positioning data and/or the map data. For example, vehicle computing system 202 determines a position of autonomous vehicle 104 within a lane in the map, and the lane is associated with map data including a unique identifier of the lane, which identifies the lane as an AV lane or a coverage lane (or a hybrid lane). In some non-limiting embodiments, map data associated with a lane defines a link between the lane and another lane, and vehicle computing system 202 determines a position (e.g., a distance, an estimated travel time, etc.) of autonomous vehicle 104 within the lane with respect to the link between the lane and the another lane (e.g., with respect to an end of the lane, an end of the another lane, etc.) based on the positioning data and the map data.

As further shown in FIG. 4, at step 406, process 400 includes controlling, in response to determining that the AV is on the coverage lane, the AV to maintain at least one functionality associated with the fully-autonomous mode. For example, autonomous vehicle 104 (e.g., vehicle computing system 202, etc.) controls, in response to determining that the autonomous vehicle 104 is on the coverage lane, autonomous vehicle 104 to maintain at least one functionality associated with the fully-autonomous mode. In some non-limiting embodiments, vehicle computing system 202 controls autonomous vehicle 104 to maintain the at least one functionality associated with the fully-autonomous mode in the coverage lane based on the position (e.g., a distance, an estimated travel time, etc.) of autonomous vehicle 104 within the coverage lane with respect to the link between the AV lane and the coverage lane. For example, vehicle computing system 202 can compare the position with respect to the link to a threshold position (e.g., a threshold distance, a threshold travel time, etc.), and control autonomous vehicle 104 to maintain the at least one functionality associated with the fully-autonomous mode in the coverage lane in response to the position with respect to the link satisfying the threshold position. As an example, vehicle computing system 202 can delay maintenance or execution of the at least one functionality associated with the fully-autonomous mode until autonomous vehicle 104 is within a threshold distance of the AV lane and/or within a threshold travel time of the AV lane, which enables reducing processing and/or system load in a portion of the coverage lane while still reducing or eliminating a processing delay associated with transitioning from the partially-autonomous mode or the manual mode to the fully-autonomous mode in the AV lane.

In some non-limiting embodiments, the at least one functionality associated with the fully-autonomous mode is not required by the partially-autonomous mode or the manual mode (e.g., is not required to be maintained or executed for partially-autonomous or manual, non-autonomous operation and/or travel of the autonomous vehicle 104). For example, some functionalities associated with the fully-autonomous mode and/or systems associated with control of fully-autonomous operation and/or travel of the autonomous vehicle 104 in or under the fully-autonomous mode are not used to operate and/or control travel of autonomous vehicle 104 in or under the partially-autonomous mode or the manual mode.

In some non-limiting embodiments, the at least one functionality associated with the fully-autonomous mode (e.g., with fully-autonomous operation of the autonomous vehicle 104 performed during fully-autonomous travel of the autonomous vehicle 104) is a functionality of at least one of the following systems: one or more sensors 206, perception system 220, prediction system 222, motion planning system 224, and/or the like. For example, the at least one functionality or system associated with the fully-autonomous mode includes at least one of the following functionalities or systems: a localization function or system (e.g., a localization function or system that uses LIDAR point clouds and/or precise pose positioning to determine a precise location of autonomous vehicle 104), an object tracking and/or classification function or system (e.g., an object tracking and/or classification function or system detects and/or tracks objects (e.g., vehicles, pedestrians, bicycles, and the like) that are proximate to (e.g., in proximity to the surrounding environment of) autonomous vehicle 104 over a time period and/or determines state data for the objects), a motion planning function or system (e.g., a motion planning function or system that determines a motion plan for autonomous vehicle 104 based on one or more cost functions), and/or the like.

In some non-limiting embodiments, autonomous vehicle 104 includes one or more sensors 206 that determine sensor data associated with an object in an environment surrounding autonomous vehicle 104, and vehicle computing system 202 controls autonomous vehicle 104 to maintain the at least one functionality associated with the fully-autonomous mode in the coverage lane based on the sensor data from the one or more sensors and/or the map data. For example, sensor(s) 206 can include a LIDAR system, and the map data can include map point data associated with a location of a number of points that correspond to objects that have reflected a ranging laser during one or more traversals of the coverage lane by one or more mapping autonomous vehicles 104. As an example, the LIDAR system determines sensor point data associated with a location of a number of points that correspond to objects within the environment of autonomous vehicle 104, and vehicle computing system 202 controls autonomous vehicle 104 to maintain the at least one functionality associated with the fully-autonomous mode to determine the sensor point data (e.g., to determine a location of autonomous vehicle 104 in the coverage lane based on the sensor point data and the map point data). For example, vehicle computing system 202 can use the sensor point data (e.g., LIDAR point clouds) and/or a precise pose positioning technique, which are associated with operation and/or travel under the fully-autonomously mode, to determine the location of autonomous vehicle 104 in the coverage lane.

As further shown in FIG. 4, at step 408, process 400 includes determining, based on the map data, that the autonomous vehicle 104 has transitioned from the coverage lane to the AV lane. For example, autonomous vehicle 104 (e.g., vehicle computing system 202, etc.) determines, based on the map data, that autonomous vehicle 104 has transitioned from the coverage lane to the AV lane. As an example, autonomous vehicle 104 can include positioning system 204 that determines positioning data associated with a position of autonomous vehicle 104 as described herein, and vehicle computing system 202 determines that autonomous vehicle 104 has transitioned from the coverage lane to the AV lane based on the positioning data and/or the map data. In some non-limiting embodiments, autonomous vehicle 104 uses the at least one functionality associated with the fully-autonomous mode (e.g., a localization function or system based on LIDAR point clouds and/or precise pose positioning to determine a precise location of autonomous vehicle 104) to determine that autonomous vehicle 104 has transitioned from the coverage lane to the AV lane.

As further shown in FIG. 4, at step 410, process 400 incudes controlling, in response to determining that that the AV has transitioned from the coverage lane to the AV lane, the AV to enter the fully-autonomous mode. For example, autonomous vehicle 104 (e.g., vehicle computing system 202, etc.) controls autonomous vehicle 104, in response to determining that autonomous vehicle 104 has transitioned from the coverage lane to the AV lane, to enter the fully-autonomous mode. As an example, vehicle computing system 202 controls one or more vehicle controls 218 (e.g., a device that controls acceleration, a device that controls steering, a device that controls braking, an actuator that controls gas flow, etc.) of autonomous vehicle 104 based on the positioning data, the sensor data, and/or the map data to control operation and/or travel of autonomous vehicle 104 under the fully-autonomous mode,

In some non-limiting embodiments, the at least one functionality associated with the fully-autonomous mode determines operation data in the coverage lane, and vehicle computing system 202 controls autonomous vehicle 104 to perform the at least one functionality in the fully-autonomous mode in the AV lane based on the operation data determined in the coverage lane by the at least one functionality associated with the fully-autonomous mode. For example, as autonomous vehicle 104 transitions from the coverage lane to the AV lane (e.g., initially enters the AV lane), vehicle computing system 202 determines a location (and/or a predicted location) of autonomous vehicle 104 and/or an object in the environment surrounding autonomous vehicle 104 based on sensor point data (e.g., LIDAR point cloud maps, etc.) associated with a geographic location of autonomous vehicle 104 determined in the coverage lane.

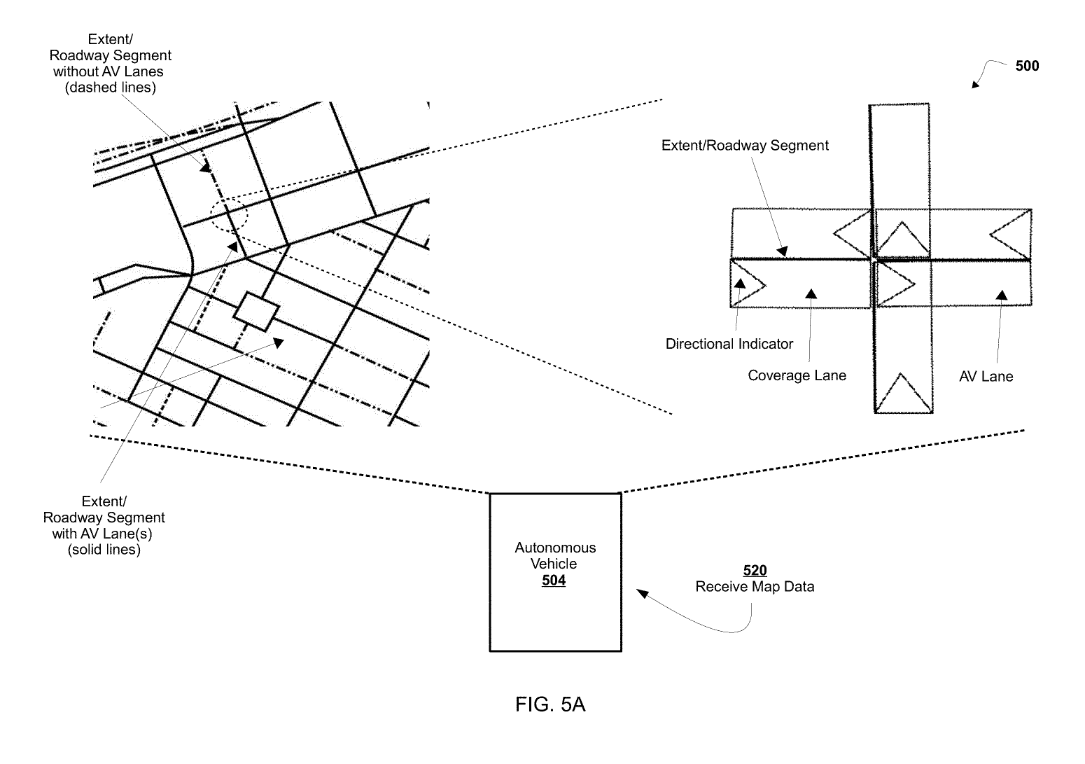

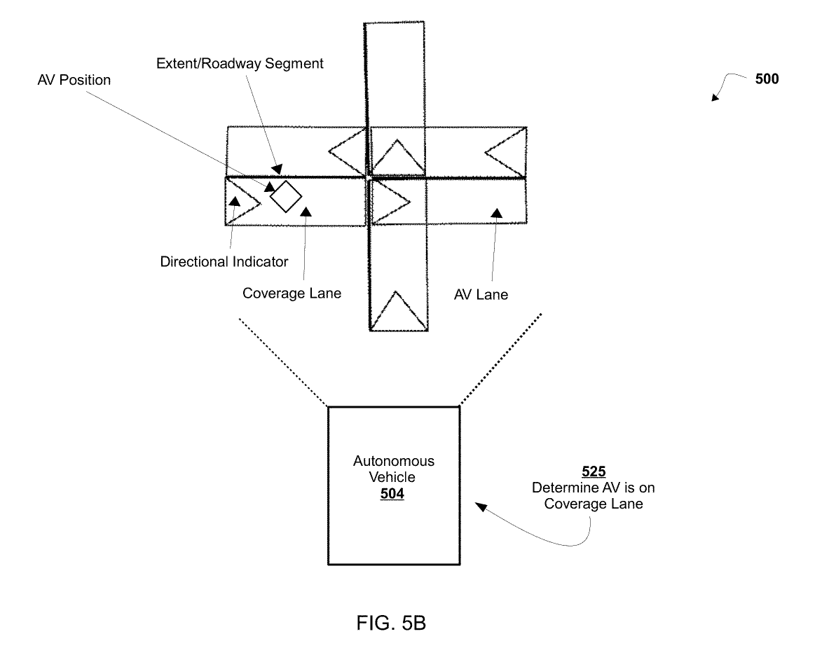

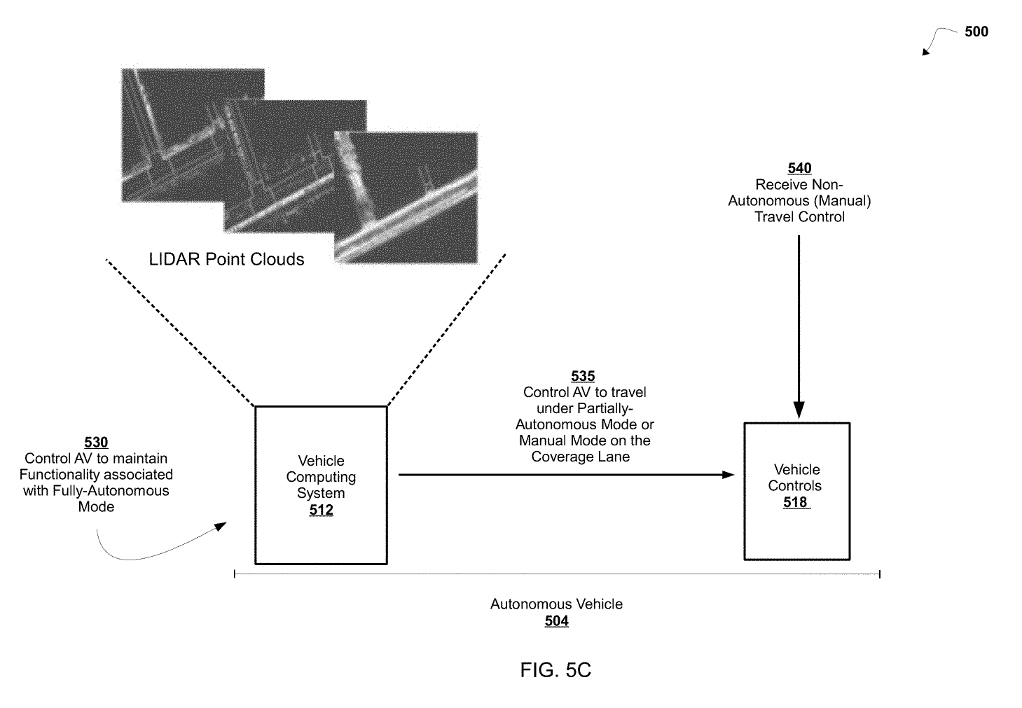

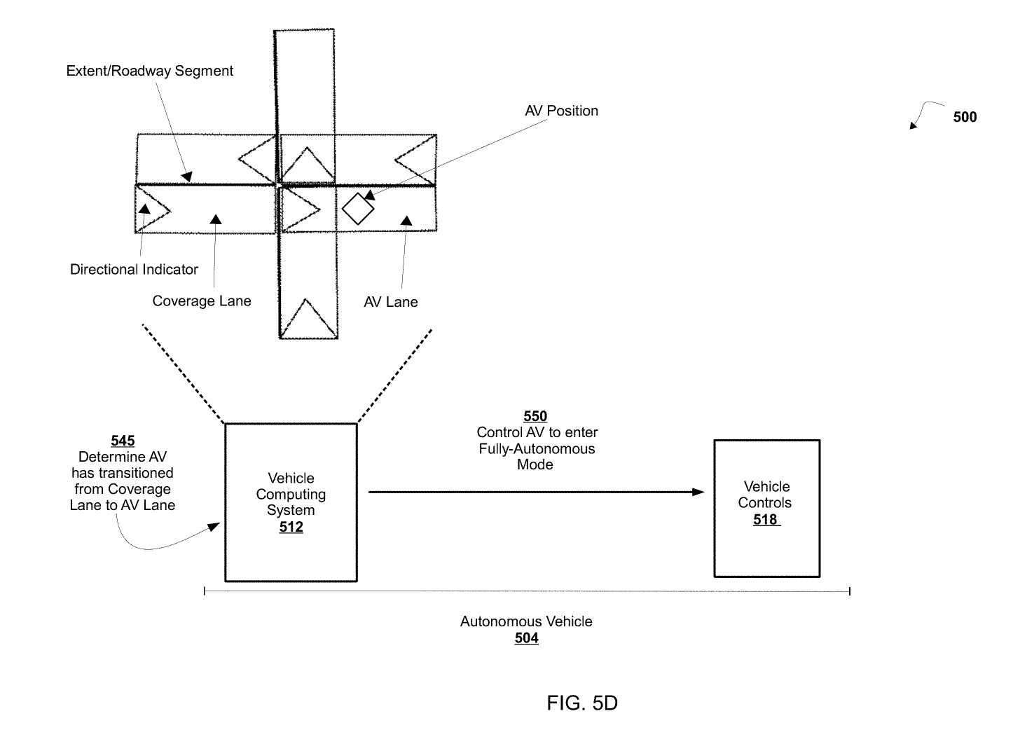

Referring now to FIGS. 5A-5D, FIGS. 5A-5D are diagrams of an overview of a non-limiting embodiment of an implementation 500 relating to a process for controlling an AV. As shown in FIGS. 5A-5D, implementation 500 may include autonomous vehicle 504, vehicle computing system 512, and vehicle controls 518. In some non-limiting embodiments, autonomous vehicle 504 may be the same or similar to autonomous vehicle 104. In some non-limiting embodiments, vehicle computing system 512 may be the same or similar to vehicle computing system 202. In some non-limiting embodiments, vehicle controls 518 may be the same or similar to vehicle controls 226.

As shown by reference number 520 in FIG. 5A, autonomous vehicle 504 receives map data associated with a map of a geographic location. In some non-limiting embodiments, the map includes (i) a coverage lane where autonomous vehicle 504 can operate and/or travel under a partially-autonomous mode or a manual mode, and (ii) an AV lane where autonomous vehicle 504 can operate and/or travel under a fully-autonomous mode, and the coverage lane is linked to the AV lane

As shown by reference number 525 in FIG. 5B, autonomous vehicle 504 (e.g., vehicle computing system 512, etc.) determines, based on the map data, that the autonomous vehicle 504 is on the coverage lane.

As shown by reference number 530 in FIG. 5C, vehicle computing system 512 controls, in response to determining that autonomous vehicle 504 is on the coverage lane, autonomous vehicle 504 to maintain at least one functionality associated with the fully-autonomous mode (e.g., a localization function or system that uses LIDAR point clouds and/or precise pose positioning, etc.). For example, as shown by reference number 535 in FIG. 5C, vehicle computing system 512 controls autonomous vehicle 504 to travel under the partially-autonomous mode or the manual mode on the coverage lane, while maintaining the at least one functionality associated with the fully-autonomous mode. As an example, as shown by reference number 540 in FIG. 5C, one or more vehicle controls 518 (e.g., a device that controls acceleration, a device that controls steering, a device that controls braking, an actuator that controls gas flow, etc.) of autonomous vehicle 504 are controlled by non-autonomous (e.g., manual, etc.) control, while maintaining the at least one functionality associated with the fully-autonomous mode (e.g., autonomous vehicle 504 continues processing and/or execution of the functionality or system) in the coverage lane under the partially-autonomous mode or the manual mode (e.g., during partially-autonomous travel or manual, non-autonomous travel of the AV in the coverage lane).

As shown by reference number 545 in FIG. 5D, vehicle computing system 512 determines, based on the map data, that autonomous vehicle 504 has transitioned from the coverage lane to the AV lane.

As shown by reference number 550 in FIG. 5D, vehicle computing system 512 controls, in response to determining that that autonomous vehicle 504 has transitioned from the coverage lane to the AV lane, autonomous vehicle 504 to enter the fully-autonomous mode. For example, vehicle computing system 512 controls one or more vehicle controls 518 (e.g., a device that controls acceleration, a device that controls steering, a device that controls braking, an actuator that controls gas flow, etc.) of autonomous vehicle 104 based on the sensor data and the hybrid map data to control operation and/or travel of autonomous vehicle 504 under the fully-autonomous mode, and, because the at least one functionality associated with the fully-autonomous mode is maintained (e.g., continues processing and/or execution of the functionality or system) in the coverage lane under the partially-autonomous mode or the manual mode (e.g., during partially-autonomous travel or manual, non-autonomous travel of the autonomous vehicle 104 in the coverage lane), vehicle computing system 512 reduces or eliminates a processing delay associated with transitioning from the partially-autonomous mode or the manual mode to the fully-autonomous mode (e.g., from partially-autonomous operation and/or travel or manual, non-autonomous operation and/or travel of the autonomous vehicle 104 in the coverage lane to fully-autonomous operation and/or travel of the autonomous vehicle 104 in the AV lane). For example, vehicle computing system 512 reduces or eliminates an initialization time, a boot time, a bootstrapping time, and/or the like associated with a functionality and/or system of the fully-autonomous mode initializing, booting, bootstrapping and/or the like before fully-autonomous travel can begin by maintaining and/or continuing processing and/or execution of the functionality or system in the partially-autonomous mode or the manual mode during partially-autonomous operation and/or travel or manual, non-autonomous operation and/or travel of the autonomous vehicle 104 in the coverage lane.

The foregoing disclosure provides illustration and description, but is not intended to be exhaustive or to limit the implementations to the precise form disclosed. Modifications and variations are possible in light of the above disclosure or may be acquired from practice of the implementations.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features can be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. An autonomous vehicle (AV) comprising:
a vehicle computing system comprising one or more processors, wherein the vehicle computing system is configured to:
receive map data associated with a map of a geographic location, the map comprising (i) a coverage lane where the AV can operate and/or travel under a partially-autonomous mode or a manual mode, and (ii) an AV lane where the AV can operate and/or travel under a fully-autonomous mode, wherein the coverage lane is linked to the AV lane;
determine, based on the map data, that the AV is on the coverage lane; and
in response to determining that the AV is on the coverage lane, control the AV to maintain at least one functionality associated with the fully-autonomous mode.

2. The AV of claim 1, wherein the vehicle computing system is further configured to:
determine, based on the map data, that the AV has transitioned from the coverage lane to the AV lane; and
in response to determining that that the AV has transitioned from the coverage lane to the AV lane, control the AV to enter the fully-autonomous mode.

3. The AV of claim 1, further comprising:
one or more sensors configured to detect an object in an environment surrounding the AV, wherein the vehicle computing system is further configured to:
control the AV to maintain the at least one functionality associated with the fully-autonomous mode in the coverage lane based on sensor data from the one or more sensors and the map data.

4. The AV of claim 3, wherein the one or more sensors include a light detection and ranging (LIDAR) system, wherein the LIDAR system is configured to determine sensor point data associated with a location of a number of points that correspond to objects within the environment of the AV, wherein the map data includes map point data associated with a location of a number of points that correspond to objects that have reflected a ranging laser during one or more traversals of the coverage lane location by one or more mapping AVs, and wherein the vehicle computing system is further configured to:
control the AV to maintain the at least one functionality associated with the fully-autonomous mode to determine a position of the AV in the coverage lane based on the sensor point data and the map point data.

5. The AV of claim 1, wherein the vehicle computing system is further or configured to:
determine, based on the map data, that the AV is on the coverage lane, by determining that the AV has transitioned from the AV lane to the coverage lane; and
in response to determining that the AV has transitioned form the AV lane to the coverage lane, control the AV to maintain at least one functionality associated with the fully-autonomous mode.

6. The AV of claim 1, wherein the at least one functionality associated with the fully-autonomous mode determines operation data in the coverage lane, and wherein the vehicle computing system is further configured to:
control the AV to perform the at least one functionality in the AV lane in the fully-autonomous mode based on the operation data determined in the coverage lane.

7. The AV of claim 1, wherein the map data is associated with a link between the AV lane and the coverage lane, the AV further comprising:
a positioning system configured to determine a position of the AV, wherein the vehicle computing system is further configured to:
determine the position of the AV with respect to the link between the AV lane and the coverage lane based on positioning data from the positioning system and the map data; and
control the AV to maintain the at least one functionality associated with the fully-autonomous mode in the coverage lane based on the position of the AV with respect to the link between the AV lane and the coverage lane.

8. A method comprising:
receiving, with a computer system comprising one or more processors, map data associated with a map of a geographic location, the map comprising (i) a coverage lane where an autonomous vehicle (AV) can operate and/or travel under a partially-autonomous mode or a manual mode, and (ii) an AV lane where the AV can operate and/or travel under a fully-autonomous mode, wherein the coverage lane is linked to the AV lane;
determining, based on the map data with the computer system, that the AV is on the coverage lane; and
in response to determining that the AV is on the coverage lane, controlling, with the computer system, the AV to maintain at least one functionality associated with the fully-autonomous mode.

9. The method of claim 8, further comprising:
determining, based on the map data with the computer system, that the AV has transitioned from the coverage lane to the AV lane; and
in response to determining that that the AV has transitioned from the coverage lane to the AV lane, controlling the AV to enter the fully-autonomous mode.

10. The method of claim 8, further comprising:
detecting, with one or more sensors, sensor data associated with an object in an environment surrounding the AV; and
controlling, with the computer system, the AV to maintain the at least one functionality associated with the fully-autonomous mode in the coverage lane based on the sensor data from the one or more sensors and the map data.

11. The method of claim 10, wherein the one or more sensors include a light detection and ranging (LIDAR) system, and wherein the map data includes map point data associated with a location of a number of points that correspond to objects that have reflected a ranging laser during one or more traversals of the coverage lane by one or more mapping AVs, the method further comprising:
determining, with the LIDAR system, sensor point data associated with a location of a number of points that correspond to objects within the environment of the AV; and
controlling, with the computer system, the AV to maintain the at least one functionality associated with the fully-autonomous mode to determine a position of the AV in the coverage lane based on the sensor point data and the map point data.

12. The method of claim 8, further comprising:
determining, with the computer system, that the AV is on the coverage lane, by determining that the AV has transitioned from the AV lane to the coverage lane; and
in response to determining that the AV has transitioned form the AV lane to the coverage lane, controlling the AV to maintain at least one functionality associated with the fully-autonomous mode.

13. The method of claim 8, wherein the at least one functionality associated with the fully-autonomous mode determines operation data in the coverage lane, the method further comprising:
controlling, with the computer system, the AV to perform the at least one functionality in the fully-autonomous mode in the AV lane based on the operation data determined in the coverage lane.

14. The method of claim 8, wherein the map data is associated with a link between the AV lane and the coverage lane of the roadway, the method further comprising:
determining, with a positioning system, positioning data associated with a position of the AV;
determining, with the computer system, a position of the AV with respect to the link between the AV lane and the coverage lane based on the positioning data and the map data; and
controlling, with the computer system, the AV to maintain the at least one functionality associated with the fully-autonomous mode in the coverage lane based on the position of the AV with respect to the link between the AV lane and the coverage lane.

15. A computing system comprising:
one or more processors configured to:
receive map data associated with a map of a geographic location, the map comprising (i) a coverage lane where an autonomous vehicle (AV) can operate and/or travel under a partially-autonomous mode or a manual mode, and (ii) an AV lane where the AV can operate and/or travel under a fully-autonomous mode, wherein the coverage lane is linked to the AV lane;
determine, based on the map data, that the AV is on the coverage lane; and
in response to determining that the AV is on the coverage lane, control the AV to maintain at least one functionality associated with the fully-autonomous mode.

16. The system of claim 15, wherein the one or more processors are further configured to:
determine, based on the map data, that the AV has transitioned from the coverage lane to the AV lane; and
in response to determining that that the AV has transitioned from the coverage lane to the AV lane, control the AV to enter the fully-autonomous mode.

17. The system of claim 15, further comprising:
one or more sensors configured to detect an object in an environment surrounding the AV,
wherein the one or more processors are further configured to control the AV to maintain the at least one functionality associated with the fully-autonomous mode in the coverage lane based on sensor data from the one or more sensors and the map data.

18. The system of claim 17, wherein the one or more sensors include a light detection and ranging (LIDAR) system, wherein the LIDAR system is configured to determine sensor point data associated with a location of a number of points that correspond to objects within the environment of the AV, wherein the map data includes map point data associated with a location of a number of points that correspond to objects that have reflected a ranging laser during one or more traversals of the coverage lane by one or more mapping AVs, and
wherein the one or more processors are further configured to control the AV to maintain the at least one functionality associated with the fully-autonomous mode to determine a position of the AV in the coverage lane based on the sensor point data and the map point data.

19. The system of claim 15, wherein the at least one functionality associated with the fully-autonomous mode determines operation data in the coverage lane, and
wherein the one or more processors are further configured to control the AV to perform the at least one functionality in the fully-autonomous mode in the AV lane based on the operation data determined in the coverage lane.

20. The system of claim 15, further comprising:
a positioning system configured to determine a position of the AV, wherein the map data is associated with a link between the AV lane and the coverage lane, wherein the one or more processors are further configured to:
determine the position of the AV with respect to the link between the AV lane and the coverage lane based on positioning data from the positioning system and the map data; and
control the AV to maintain the at least one functionality associated with the fully-autonomous mode in the coverage lane based on the position of the AV with respect to the link between the AV lane and the coverage lane.
